(19) United States
(12) Patent Application Publication
(10) Pub. No.: US 2026/0244716 A1
(43) Pub. Date: Aug. 20, 2026

(54) TimeCurrency Protocol Module 3 Continuous Value Application & Universal IoT Integration Module for Real-Time TimeToken Utilization Across All Entities, Currencies, Behaviors, Times, and Resources

(71) Applicant: FURONG BEI, SAN GABRIEL, CA (US)

(72) Inventor: FURONG BEI, SAN GABRIEL, CA (US)

(21) Appl. No.: 19/183,293

(22) Filed: Apr. 18, 2025

(51) Int. Cl. G06F 21/10; H04L 9/32

(52) U.S. Cl. CPC G06F 21/1014; H04L 9/3236

(57) ABSTRACT

A computer-implemented TimeCurrency system provides a BEI Identifier-bound settlement-grade admission gate for continuous value streaming and Internet-of-Things resource settlement. The system registers devices, gateways, services, resources, or behavior-event sources; resolves a protocol-native BEI Identifier; and rejects signed usage-event records unless identifier status, endpoint status, policy authorization, signature verification, nonce or counter replay-prevention, time-window validity, and settlement-state conditions are satisfied. Accepted records update streamPay fractional TimeToken streams, generate TimeYield rewards, reconcile cached signed records from intermittent connectivity, and commit tamper-evident settlement-grade records. The records may be consumed by BEI or third-party compatible wallets, audit endpoints, marketplaces, index endpoints, clearing endpoints, licensing endpoints, certification endpoints or domain gateways thereby converting unverified telemetry into verified, market-eligible, audit-ready, and license-ready settlement records.

### TECHNICAL FIELD

The disclosure relates to distributed ledger systems, Internet-of-Things metering, resource accounting, microtransaction infrastructure, streaming payment systems, time-denominated value units, protocol-native identifiers, dynamic reward calculation, behavior-triggered token issuance, and auditable settlement records.

More particularly, the disclosure relates to a BEI Identifier-bound TimeCurrency module that registers connected devices, services, behavior sources, and resource categories; manages fractional TimeToken streams; calculates TimeYield rewards; validates usage-event records; reconciles intermittent device records; and records tamper-evident settlement commitments.

The disclosed module may be implemented as BEI IoT, BEI Bridge, BEI Flow, BEIMINTING, BEITOKEN, BEINFT, BEI Market, BEI Treasury, BEI Trust, BEI TLD, or equivalent endpoint implementations, without limiting the invention to any particular domain name, brand, operator, network, ledger, wallet, marketplace, exchange, clearinghouse, or commercial deployment.

### BACKGROUND

Conventional payment systems generally process discrete transactions. A user requests a service or purchases an asset, and a billing system records a single transaction. Such systems are poorly suited for connected devices and resources that are consumed continuously, intermittently, or in small time windows, including compute cycles, bandwidth, energy, sensor output, API calls, physical asset access, service access, and behavior-time events.

IoT platforms typically collect telemetry, while economic settlement is performed later by a separate billing platform. This separation creates fragmented records: a device identifier may live in a telemetry database, an account identifier in a wallet, a payment reference in a processor, a behavior tag in an application, and a settlement receipt in a ledger. Fragmented records reduce auditability and create duplicate, stale, or unverifiable settlement risk.

Token streaming and digital asset systems may transfer value over time, but many do not bind resource usage to device registration, behavior tags, time windows, policy profiles, TimeYield rewards, fallback reconciliation, and auditable settlement records. Many also assume continuous connectivity, which is not reliable for field devices, remote sensors, vehicles, meters, edge gateways, and mobile assets.

There is a need for a machine-implementable bridge between BEI Identifier-bound device events and TimeCurrency settlement. The bridge should register devices and resources, generate or resolve protocol-native identifiers, open and control fractional TimeToken streams, calculate dynamic TimeYield rewards, validate signed usage records, support fallback off-chain settlement, and publish settlement records suitable for wallets, audit systems, marketplaces, and downstream clearing or index endpoints.

### SUMMARY

The invention provides a BEI Identifier-bound continuous value streaming and universal IoT settlement system for a TimeCurrency protocol. The system includes a BEI Identifier binding engine, a streamPay microtransaction engine, a bindIoT registration engine, a TimeYield reward engine, a usage-event validation engine, a fallback reconciliation engine, a ledger record engine, and an endpoint gateway.

The BEI Identifier binding engine generates or resolves a protocol-native BEI Identifier for connected entities, devices, gateways, behavior tags, time windows, currency streams, resource categories, usage events, TimeYield records, minting records, settlement records, or audit commitments. In certain embodiments, the BEI Identifier may comprise or reference an OmniID implementation; however, the disclosed architecture is not limited to any particular commercial identifier name or third-party identifier product.

The streamPay engine opens, pauses, resumes, partially settles, and closes fractional TimeToken streams. The bindIoT engine registers devices, services, gateways, behavior sources, or resources and binds them to resource categories, TimeToken accounts, policy profiles, endpoint references, and settlement records. The TimeYield engine calculates rewards based on demand, scarcity, latency, availability, reliability, stake amount, or policy parameters.

The fallback reconciliation engine permits devices or gateways to cache signed usage records during intermittent connectivity and later reconcile counters, nonces, validity windows, signatures, meter readings, and ledger commitments. The ledger record engine creates tamper-evident usage, minting, reward, and settlement records. The endpoint gateway routes protocol messages to BEI or third-party endpoints, including non-limiting identifier, identity, IoT, minting, token, evidence-token, marketplace, wallet, audit, index, compliance, clearing, exchange, currency-reference, treasury, trust, and domain-gateway endpoints.

### BRIEF DESCRIPTION OF THE DRAWINGS

FIG. 1: Overall BEI Identifier-bound TimeCurrency IoT settlement architecture.

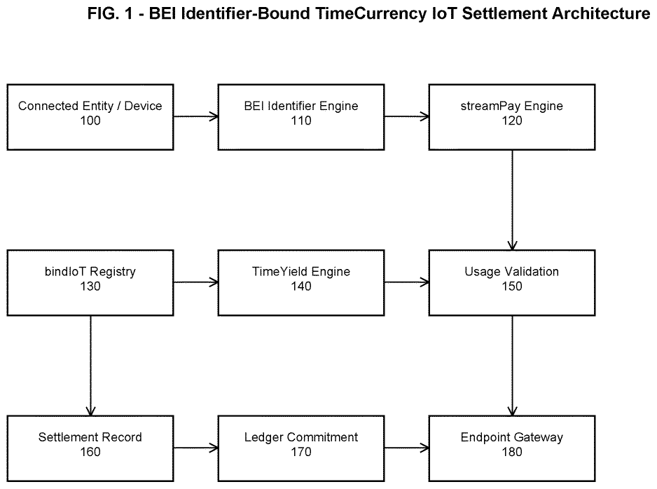

FIG. 2: BEI Identifier framework and optional OmniID implementation record.

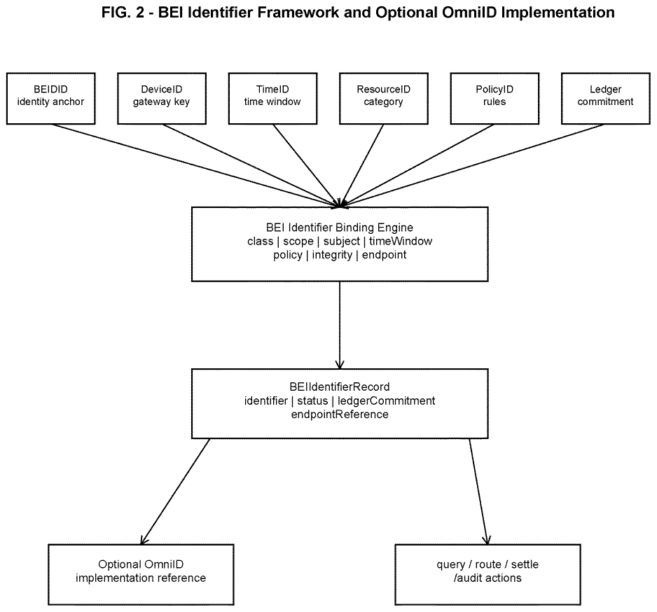

FIG. 3: streamPay state machine for fractional TimeToken streams.

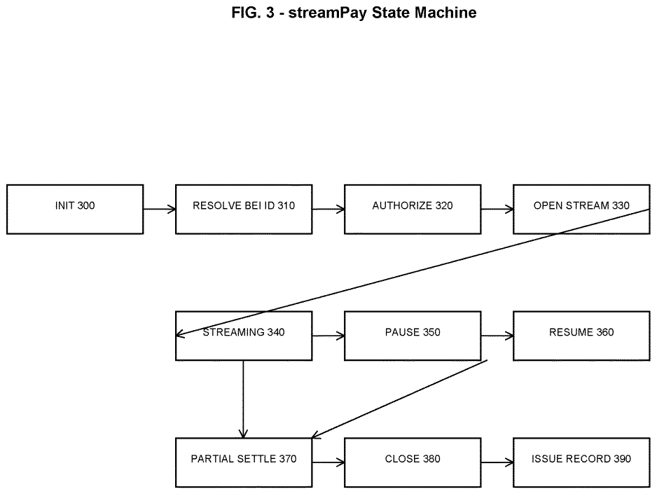

FIG. 4: bindIoT registration and device/resource binding workflow.

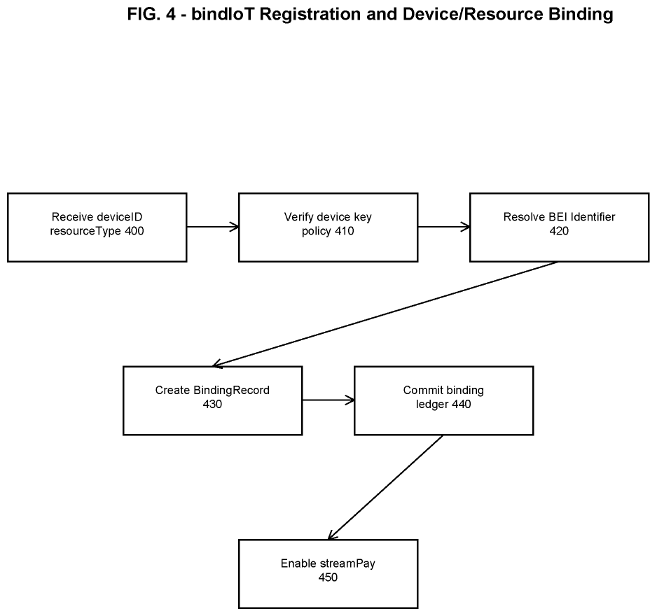

FIG. 5: TimeYield dynamic reward engine.

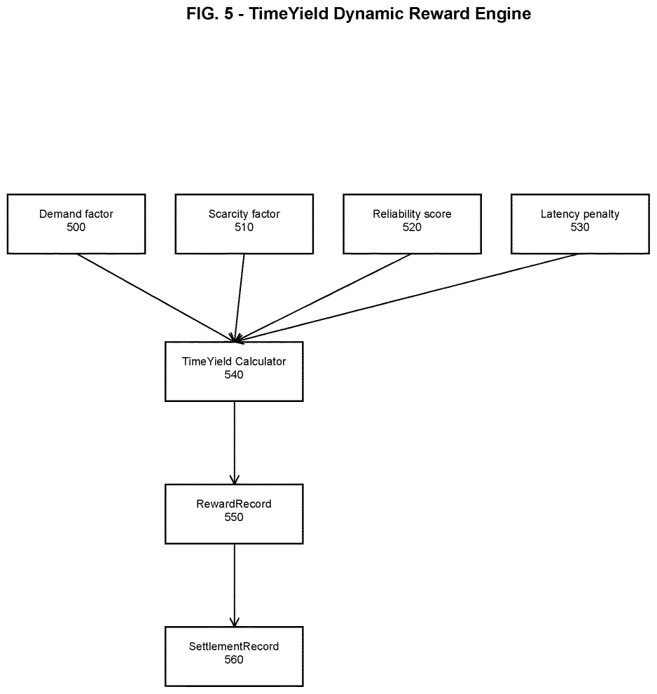

FIG. 6: Usage-event validation and settlement-record generation.

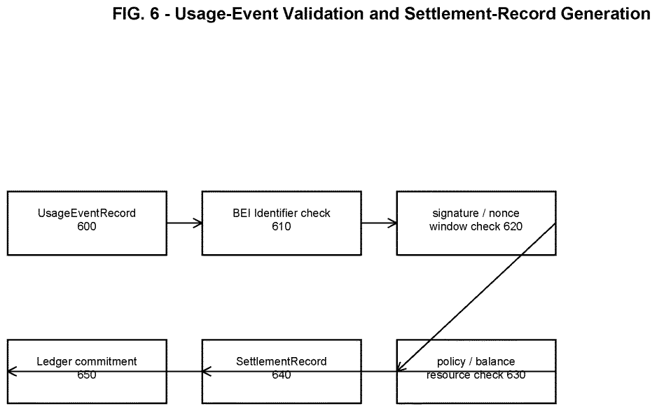

FIG. 7: Fallback off-chain settlement and reconciliation.

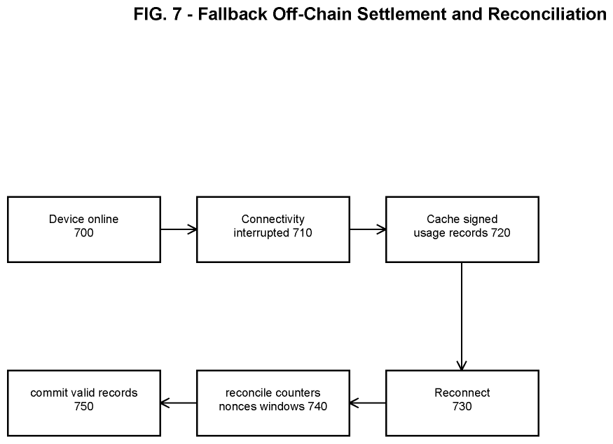

FIG. 8: BEI Bridge, BEI Flow, BEI IoT, and Domain Gateway endpoint routing.

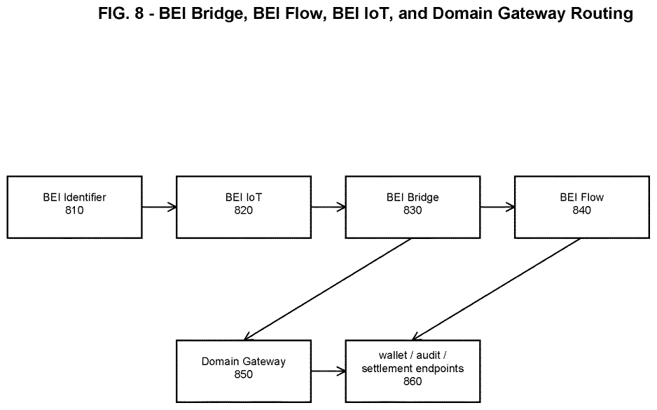

FIG. 9: BEIMINTING, BEITOKEN, BEINFT, and BEI Market endpoint pathway.

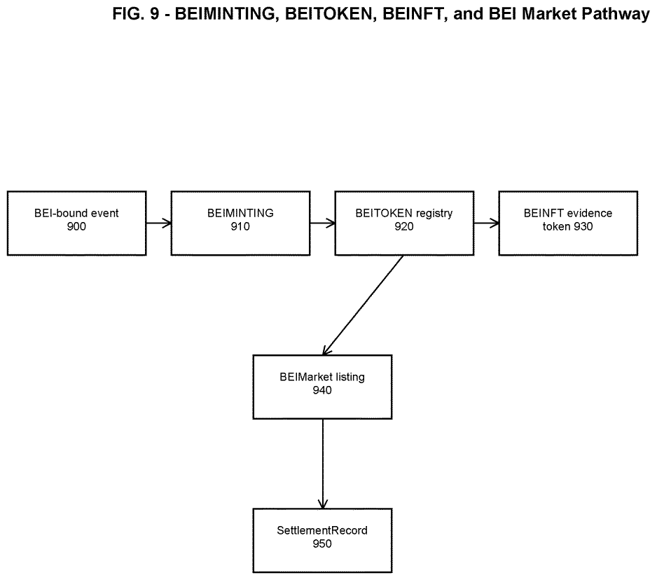

FIG. 10: Downstream BEIIndex, BEISEC, BEICX, BEIGX, BEISX, and currency-reference endpoint interoperability.

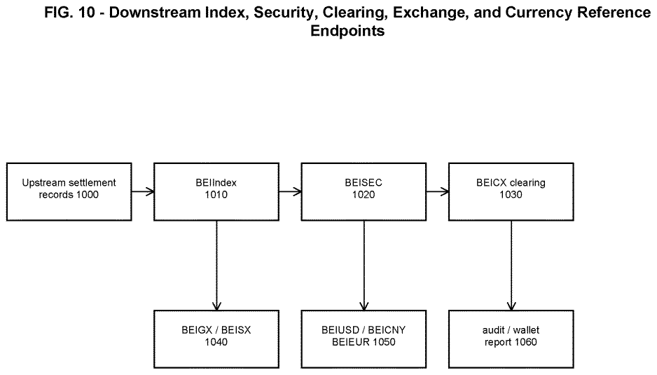

### DETAILED DESCRIPTION

### 1. Overview of the BEI IoT TimeCurrency Bridge

The disclosed module functions as a technical bridge between BEI Identifier-bound events and TimeCurrency settlement records. A device, service, gateway, behavior source, or resource is registered; a BEI Identifier is generated or resolved; a time window and resource category are bound; a streamPay session or behavior-triggered minting event is evaluated; a TimeToken stream, TimeCurrency unit, or time-denominated credit is issued or debited; a TimeYield reward may be computed; and a settlement record is committed for audit.

The bridge is not merely a web site or business label. It is a machine workflow requiring identifiable records, state transitions, signatures, counters, policy profiles, ledger commitments, and queryable settlement records. A deployment may be called BEI IoT, BEI Bridge, BEI Flow, BEIMINTING, or another BEI ecosystem name, but the technical architecture remains the BEI Identifier-bound streaming, reward, validation, reconciliation, and settlement system described herein.

In one useful deployment, a smart energy meter, edge compute node, bandwidth gateway, sensor feed, API service, physical asset controller, or behavior-event source is bound to a BEI Identifier. Each valid usage window becomes a TimeCurrency event rather than an isolated telemetry record. This permits wallets, dashboards, market endpoints, and audit systems to query a coherent chain from device or behavior evidence to settlement state.

### 2. BEI Ecosystem Definitions and Nomenclature

BEI Identifier means a protocol-native identifier used within a BEI or TimeCurrency system to identify, bind, route, verify, query, settle, and audit an entity, account, device, gateway, behavior tag, time window, resource category, currency stream, usage event, TimeYield record, minting record, evidence-token reference, or settlement record.

BEIDID means a BEI decentralized identifier or identity anchor associated with a person, entity, device owner, service provider, organization, verifier, account, or gateway. A BEIDID may be used for authentication, authorization, attestation, wallet binding, device ownership, policy eligibility, and settlement accountability.

BEI-IDF means a BEI Identifier Framework defining identifier classes, scopes, subject fields, time-window fields, policy fields, integrity fields, endpoint references, status fields, and ledger-commitment fields for BEI-linked objects. The framework may include TimeID, BehaviorID, DeviceID, ResourceID, TokenID, ReceiptID, SettlementID, or other identifier classes.

TimeCurrency means a time-denominated value system in which time windows, usage events, behavior-time events, services, devices, resources, or settlement records may be represented by value units, credits, tokens, or ledger entries. TimeToken means a fractional or whole unit used by a TimeCurrency protocol to represent a streamed value amount, reward amount, minting amount, or settlement amount.

BEIMINT means a BEI minting engine that evaluates BEI Identifier-bound usage events, behavior-time events, device records, resource records, or attestation references and issues TimeTokens, TimeCurrency units, BEI-linked value units, or time-denominated credits according to a policy profile. BEIMINTING means the workflow layer that performs event validation, minting eligibility evaluation, receipt generation, and ledger commitment.

BEI IoT means a BEI endpoint or module family for device registration, resource binding, streamPay sessions, TimeYield records, fallback reconciliation, and audit queries. BEI Bridge means an interoperation layer that connects BEI Identifier services, BEIDID identity anchors, IoT device binding, streamPay, TimeYield, BEIMINT, wallet, marketplace, audit, and settlement endpoints. BEI Flow means a value-flow layer coordinating usage events, TimeToken streams, TimeYield rewards, settlement records, and audit commitments.

### 3. Protocol-Native BEI Identifier Layer

The BEI Identifier layer provides the admission gate by which an IoT device, resource category, behavior-time event, TimeToken stream, TimeYield reward, and settlement record are recognized as belonging to the same TimeCurrency transaction path. Without the BEI Identifier binding, a device reading is merely telemetry, a payment stream is merely a transfer, and a ledger entry is merely an isolated record. With the binding, they form a machine-verifiable settlement path.

A BEI Identifier may be persistent for an entity, device, gateway, or account; session-level for a particular stream; event-level for a usage record; or receipt-level for a settlement record. In certain embodiments, a BEI Identifier may comprise or reference an OmniID implementation. References to OmniID herein denote an implementation-specific universal binding identifier within the disclosed TimeCurrency protocol and do not require any external RFID tag product, vendor identifier, or third-party commercial identifier system.

A non-limiting BEI Identifier record may include identifier, class, scope, subject, timeWindow, policyID, endpointReference, integrityCode, ledgerCommitment, and status. The record may be encoded as JSON, XML, protocol buffers, database fields, smart contract call data, device firmware messages, or another machine-readable form.

### 4. BEIIdentifierRecord Data Structure

In one embodiment, the BEIIdentifierRecord includes a class field indicating entity, account, device, gateway, behavior, time window, resource, token stream, usage event, TimeYield record, minting record, evidence-token reference, or settlement record. The scope field identifies a domain, application, resource category, service provider, marketplace, wallet, IoT network, or policy environment. The subject field stores a public key, device serial, resource code, account reference, behavior tag, hash, or other machine-readable value.

The timeWindow field binds the identifier to a settlement or audit interval. The policyID field identifies the signed or versioned policy profile controlling authorization, rate, reward, fallback settlement, minting eligibility, or audit requirements. The endpointReference field may identify a domain gateway, device-binding service, wallet, market endpoint, audit endpoint, or settlement endpoint. The integrityCode may include a checksum, hash, signature, Merkle commitment, ledger commitment, or equivalent tamper-evident value.

By structuring the BEI Identifier as an operative record rather than a mere label, the system improves technical operation. The identifier controls whether a stream may open, whether a device may submit usage events, whether a TimeYield reward may accrue, whether a behavior-time event may trigger issuance, whether a settlement record may be accepted, and whether a queryOmniHub response may return audit data.

### 5. BEIDID Identity Anchor

The BEIDID identity anchor may be associated with a person, organization, service provider, device owner, gateway operator, marketplace operator, account, verifier, or auditor. The BEIDID may include a public key, jurisdiction or policy scope, verification tier, key rotation status, revocation status, and relationship to accounts or devices. The BEIDID may be stored directly in a ledger, referenced by a commitment, or resolved through a BEI Identifier endpoint.

In an IoT deployment, a device may be associated with a device key and a device owner BEIDID. The BEIDID does not need to reveal private identity data in every transaction. A usage event may store a commitment or reference sufficient to prove that the event is associated with an authorized party while preserving data minimization and policy-controlled disclosure.

BEIDID integration allows the disclosed module to distinguish telemetry from accountable settlement. A sensor reading from an unbound device may be rejected, while a signed reading from a device associated with an active BEIDID and policy profile may be admitted into streamPay, TimeYield, BEIMINTING, or settlement workflows.

### 6. streamPay Continuous Value Stream

The streamPay engine manages fractional TimeToken streams. A stream may be opened for a service, asset, behavior source, connected device, gateway, API, compute resource, bandwidth resource, energy meter, data feed, sensor output, physical asset, or other resource category. The stream may accrue continuously, periodically, or upon receipt of usage-event records.

A streamPay request may include an entity reference, resource reference, account reference, requested duration, maximum amount, policy identifier, client nonce, and endpoint reference. The response may include a stream identifier, resolved BEI Identifier, authorized rate, policy version, current state, counter range, settlement window, and signature.

The streamPay state machine may include INIT, RESOLVE_IDENTIFIER, AUTHORIZE, STREAMING, PAUSE, RESUME, PARTIAL_SETTLE, CLOSE, ISSUE_RECORD, DISPUTE, and ARCHIVE states. Each state has defined inputs, outputs, failure checks, ledger actions, and transition conditions. This state structure makes continuous TimeCurrency settlement deterministic and auditable.

### 7. bigidIo Device and Resource Registration

The bindIoT engine registers devices, gateways, services, resource controllers, physical assets, behavior sources, and resource categories. A bindIoT request may include deviceID, device public key, device class, firmware version, resource type, geographic parameter, account reference, policyID, endpoint reference, and signature. The engine may verify device signatures, challenge possession of a key, validate resource categories, and associate the device with a BEI Identifier.

Resource categories may include compute, bandwidth, energy, storage, data, sensor output, physical asset usage, mobility, service access, API calls, behavior-event source, settlement gateway, or other policy-defined category. The resource category determines rate tables, TimeYield programs, fallback settlement rules, audit requirements, and domain endpoint routing.

The binding record may include deviceID, BEI Identifier, optional OmniID implementation reference, resourceCategory, TimeTokenAccount, policyID, endpointHash, signature, ledgerCommitment, and status. Device states may include pending, active, suspended, revoked, retired, disputed, or archived.

### 8. UsageEventRecord Validation

A usage-event record represents a metered event that may cause a debit, credit, reward, issuance, audit entry, or settlement record. The event may originate from a device, service, gateway, human behavior source, application, domain endpoint, marketplace, or wallet. The event is preferably signed by a device key, gateway key, service key, account key, or authorized endpoint key.

A non-limiting UsageEventRecord includes eventID, BEI Identifier, optional OmniID implementation reference, deviceID, resourceID, behaviorTag, startTime, endTime, duration, rate, meterReading, nonce, counter, validityWindow, policyID, signature, and settlementRecordID. Not every field is required in every embodiment; fields may be hashed, encrypted, tokenized, stored off-chain, or referenced by ledger commitment.

Validation checks may include identifier resolution, policy status, signature validity, counter monotonicity, nonce uniqueness, time-window validity, device status, resource availability, account balance, meter-reading consistency, rate limits, and duplicate-settlement detection. Standardized result codes may include VALID, STALE_WINDOW, DUPLICATE_NONCE, INVALID_SIGNATURE, POLICY_EXCEEDED, DEVICE_REVOKED, METER_CONFLICT, INSUFFICIENT_BALANCE, RATE_LIMITED, and PENDING_RECONCILIATION.

### 9. TimeYield Dynamic Reward Engine

The TimeYield engine dynamically calculates rewards for validators, service providers, device owners, resource providers, gateway operators, or other policy-defined participants. Rewards may be computed for each second, minute, hour, session, epoch, or policy-defined time window. The engine may consider demand, scarcity, latency, availability, reliability, stake amount, service quality, utilization, dispute rate, or policy multiplier.

In one non-limiting example, rewardRate equals baseRate multiplied by demandFactor, scarcityFactor, reliabilityScore, and policyMultiplier, divided by latencyPenalty. Other functions, lookup tables, machine-generated coefficients, smart contract formulas, or policy-defined formulas may be used. The formula is illustrative and not limiting.

A TimeYieldRecord may include accountID, BEI Identifier, resourceCategory, rewardWindow, demandFactor, scarcityFactor, latencyFactor, availabilityFactor, reliabilityScore, baseRate, policyMultiplier, rewardAmount, and settlementRecordID. The record may be displayed in a wallet, queried by a dashboard, supplied to BEI Flow, or routed to downstream market, index, or treasury endpoints as permitted by policy.

### 10. BEIMINTING Behavioral and Resource Minting Layer

The BEIMINTING layer processes BEI Identifier-bound usage events, behavior-time events, device records, resource records, or attestation references. It evaluates policy, eligibility, event quality, time-window validity, device trust, source reliability, previous issuance, risk limits, and settlement state. If eligible, it may issue a TimeToken, TimeCurrency unit, BEI-linked value unit, time-denominated credit, or token record.

A BehavioralMintingRecord or ResourceMintingRecord may include mintingID, BEI Identifier, timeWindow, behaviorTag, resourceID, evidenceReference, policyID, eligibilityValue, issuedUnitType, issuedAmount, settlementRecordID, ledgerCommitment, and status. The evidence may remain off-chain while a hash or commitment is stored in the settlement record.

BEIMINTING differs from a mere rewards program because the minted amount is not isolated from audit and settlement. The issued unit is linked to the BEI Identifier, event source, time window, policy profile, settlement record, and ledger commitment. This permits downstream BEITOKEN, BEINFT, wallet, marketplace, index, treasury, or audit endpoints to verify the issuance path.

### 11. BEITOKEN Registry Endpoint

In some embodiments, token metadata and status may be managed by a BEITOKEN registry endpoint or equivalent token registry endpoint. A token registry endpoint may store or reference token class, TimeToken compatibility, issuer, policy profile, resource category, minting record, settlement record, wallet display information, status, and audit commitment.

The token registry is not required to be hosted by any particular domain name. Non-limiting examples may include BEITOKEN endpoints, BEITOKEN application endpoints, BEITOKEN protocol endpoints, or third-party compatible token registries. The technical function is to preserve machine-readable token metadata linked to the BEI Identifier-bound event and settlement path.

### 12. BEINFT Evidence—Token Endpoint

In some embodiments, evidence records, usage-event commitments, minting receipts, settlement records, device-binding records, audit proofs, or license references may be represented by non-fungible evidence tokens. A BEINFT endpoint or equivalent evidence-token endpoint may create, reference, display, transfer, license, or audit such evidence tokens according to a policy profile.

The evidence token may not contain raw private evidence. Instead, it may reference a hash, encrypted pointer, IPFS or content-addressed object, ledger commitment, or policy-controlled evidence store. This approach allows a device binding, behavior event, TimeYield reward, or settlement state to be used in downstream marketplaces or audit systems without requiring public disclosure of sensitive data.

### 13. BEI Bridge and BEI Flow Endpoint Layer

In some BEI ecosystem embodiments, the disclosed module operates as a BEI Bridge between BEI Identifier-bound device events and TimeCurrency settlement records. The BEI Bridge layer may connect BEI Identifier services, BEIDID identity anchors, IoT device-binding endpoints, streamPay endpoints, TimeYield endpoints, BEIMINT endpoints, wallet endpoints, marketplace endpoints, audit endpoints, and settlement endpoints.

In some embodiments, the module operates as a BEI Flow layer. BEI Flow coordinates usage-event flow, TimeToken flow, TimeYield flow, minting flow, settlement flow, and audit flow. A flow may begin with an IoT device reading, API call, behavior-time event, or resource-access event and may end with a settlement record, wallet update, evidence token, marketplace listing, or audit query response.

Non-limiting ecosystem examples include BEIBridge endpoints, BEIFlow endpoints, BEIIoT endpoints, BEIMINT endpoints, BEITOKEN endpoints, BEINFT endpoints, BEIMarket endpoints, BEIIndex endpoints, BEISEC endpoints, BEICX endpoints, BEIGX endpoints, BEISX endpoints, BEIUSD endpoints, BEICNY endpoints, BEIEUR endpoints, BEITIME endpoints, BEI Treasury endpoints, BEI Trust endpoints, and BEI TLD or Domain Gateway endpoints. These examples do not limit the invention to any particular website or commercial venue.

### 14. BEI Ecosystem Endpoint Examples

In non-limiting BEI ecosystem implementations, the disclosed BEI Identifier-bound TimeCurrency IoT settlement module may interoperate with BEI-controlled or third-party service endpoints. Such endpoints may include, without limitation, identifier endpoints, BEIDID identity-anchor endpoints, BEI-IDF framework endpoints, IoT device-binding endpoints, BEI Bridge endpoints, BEI Flow endpoints, streamPay endpoints, TimeYield endpoints, BEIMINT or BEIMINTING minting endpoints, BEITOKEN registry endpoints, BEINFT evidence-token endpoints, BEIMarket or BEIMarkets marketplace endpoints, wallet endpoints, audit endpoints, settlement endpoints, index endpoints, compliance endpoints, clearing endpoints, exchange endpoints, treasury endpoints, trust endpoints, TLD or Domain Gateway endpoints, and currency-reference endpoints.

Examples of BEI-controlled endpoint names may include beiidentifier.com, beidid.com, beiidf.com, beiiot.app, beiiot.org, beiiots.com, beiiot.us, beibridge.com, beiflow.com, beimint.com, beiminting.com, beitoken.com, beitoken.app, beitoken.org, beitokens.com, beitokens.org, beinft.com, beimarket.com, beimarkets.com, beicurrency.com, beitimecurrency.com, tmcur.com, beiusd.com, beicny.com, beieur.com, beigx.com, beicx.com, beisx.com, beiindex.com, beisec.com, beitime.app, beitime.org, beitimeid.com, beitimechain.com, beitimecore.com, beitimeminting.com, beitreasury.com, beitreasury.org, beitrust.org, beitld.com, and beiterminal.com.

These endpoint examples are illustrative only. The invention is not limited to any particular domain name, website, brand, operator, ledger, wallet, marketplace, exchange, clearinghouse, treasury, trust provider, index provider, compliance provider, identity provider, or commercial implementation. Equivalent systems that perform BEI Identifier-bound device registration, TimeCurrency streaming, TimeYield calculation, usage-event validation, settlement-record generation, fallback reconciliation, endpoint routing, or audit commitment are within the scope of the disclosed technical architecture.

### 15. BEITIME Endpoint Family

The BEITIME endpoint family may provide time-window identity, TimeID binding, TimeCurrency documentation, TimeToken streaming, TimeChain records, time-based minting, and TimeYield dashboards. Non-limiting examples may include BEITIME application endpoints, BEITIME protocol endpoints, BEITIME identity endpoints, BEITIME core endpoints, BEITIME chain endpoints, and BEITIME minting endpoints.

In the disclosed module, BEITIME endpoints are not required for every implementation. They are examples of endpoint families that can consume or provide BEI Identifier-bound time windows, TimeToken streams, TimeYield records, settlement records, or audit commitments. The same technical functions may be performed by third-party endpoints or by generic TimeCurrency endpoints.

### 16. BEI Treasury, Trust, and TLD Endpoint Families,

BEI Treasury endpoints may hold, reserve, escrow, display, or settle TimeTokens, TimeCurrency units, BEI-linked value units, pending rewards, or settlement-state balances. A treasury endpoint may receive settlement records, commit reserve states, release unused balances, or support TimeYield distribution. BEI Treasury endpoints are examples of reserve, vault, escrow, or settlement-state endpoints and are not required by name.

BEI Trust endpoints may provide identity verification, device trust, policy verification, audit authorization, verifier scoring, or trust-tier management. BEI TLD or Domain Gateway endpoints may provide namespace routing, endpoint discovery, policy-based service resolution, domain-specific route selection, and endpoint signature verification. These endpoint families support the bridge from identifier-bound events to auditable settlement.

### 17. Domain Gateway and Infrastructure, Interoperability

A Domain Gateway Module may route TimeCurrency, BEI Identifier, IoT usage, audit, settlement, or policy-related messages to domain-specific service endpoints. Such endpoints may include identity verification endpoints, device-binding endpoints, streaming-payment endpoints, TimeYield subscription endpoints, OmniHub or BEI Identifier query endpoints, audit endpoints, wallet endpoints, marketplace endpoints, settlement endpoints, and policy endpoints.

The Domain Gateway may select a route based on BEI Identifier metadata, resource category, time window, policy profile, geographic parameter, endpoint availability, device trust, or settlement state. Endpoint records may include endpoint type, endpoint URL, public key, policy version, effective time window, signature, and status. Expired or unsigned endpoint records may be rejected.

An Infrastructure Empowerment Module may provide identity, navigation, communication, time, or domain-context features used by the TimeCurrency module. Such integration may occur through APIs, SDKs, smart contracts, message queues, edge gateways, cloud connectors, or domain-specific service connectors.

### 18. Fallback Off-chain Settlement

Fallback off-chain settlement channels support intermittent connectivity. A device, gateway, or local service may continue measuring usage while disconnected from a remote ledger or service. During disconnection, the device or gateway may create signed local usage records with sequence counters, nonces, time windows, meter readings, BEI Identifier references, and policy references.

When connectivity is restored, the fallback reconciliation engine receives cached records, validates signatures, checks counters and nonces, verifies time windows, compares meter readings, and rejects duplicates or stale records. Valid records are converted into settlement records and committed to a ledger or tamper-evident audit structure.

This mechanism is particularly useful for energy meters, mobile assets, remote sensors, vehicles, medical devices, industrial IoT, agricultural sensors, edge compute nodes, emergency networks, and other devices that cannot guarantee continuous network availability. It also prevents a disconnected device from escaping audit merely because it was offline during use.

### 19. Settlement Records and Receipt Identifiers

A settlement record may correspond to a partial stream settlement, final stream settlement, TimeYield reward, behavior-triggered issuance, device binding event, policy update, fallback reconciliation result, evidence-token reference, or audit event. The record may include settlementRecordID, BEI Identifier, optional OmniID implementation reference, eventID, payerAccount, providerAccount, TimeTokenAmount, referenceAmount, settlementState, policyID, timestamp, signature, and ledgerCommitment.

A ReceiptID may identify a usage receipt, mint receipt, reward receipt, settlement receipt, audit receipt, correction receipt, fallback reconciliation receipt, or dispute-resolution receipt. The ReceiptID makes each step queryable. A wallet, marketplace, BEI Flow endpoint, BEI Treasury endpoint, audit system, or downstream clearing endpoint may use the ReceiptID to verify the status of the event without downloading all private evidence.

### 20. Security, Anti-Replay, and Data Minimization

The system may use signatures, nonces, counters, validity windows, ledger commitments, device keys, account keys, endpoint keys, policy signatures, revocation lists, and endpoint verification to reduce fraud, replay, duplicate settlement, and unauthorized access. Each usage event may include a nonce, counter, or sequence number. Duplicate counters may be rejected, and missing counters may be flagged for reconciliation.

Detailed evidence may remain off-chain while commitments are stored in settlement records. Query responses may reveal different fields depending on requester role, policy, jurisdiction, trust tier, device status, or audit authorization. A user may see personal records, a device owner may see device records, a service provider may see service-level totals, and an auditor may see commitments and verification statuses.

The system may separate endpoint names from endpoint functions. A BEI-controlled domain may host an endpoint, but the domain name is not the technical subject matter. The technical subject matter is the authenticated flow from BEI Identifier-bound events to TimeCurrency streaming, TimeYield calculation, settlement records, fallback reconciliation, and audit commitments.

### 21. Downstream Market, Index, Clearing, and Compliance Endpoints

The disclosed BEI IoT TimeCurrency module may serve as an upstream event, usage, TimeYield, minting, evidence-token, and settlement-record source for downstream market, index, clearing, exchange, currency-reference, compliance, treasury, or audit endpoints. These downstream endpoints may display, list, license, route, reconcile, index, or audit records generated by the disclosed module.

In non-limiting examples, a BEI Market endpoint may receive verified usage-event records, TimeToken streams, TimeYield records, device-binding records, minting records, settlement records, or evidence-token references for listing, discovery, licensing, access-control, pricing-reference, audit-query, or settlement-routing functions. A BEIIndex endpoint may compute signed analytics or index reports from usage-event records, TimeToken streams, TimeYield records, and settlement records.

BEICX, BEIGX, BEISX, BEIUSD, BEICNY, BEIEUR, and BEISEC are examples of downstream clearing, exchange, currency-reference, and compliance endpoints. The present module does not require any particular downstream venue, but it provides verified upstream records that such downstream endpoints may consume.

### 22. Marketplace and Licensing Interface

A marketplace endpoint may display or list device usage rights, resource access rights, TimeYield records, TimeToken streams, BEITOKEN metadata, BEINFT evidence tokens, settlement receipts, or license packages. The marketplace endpoint may call queryOmniHub or an equivalent BEI Identifier query function to retrieve record status, commitments, totals, policy scope, eligibility, and audit status.

In one embodiment, an IoT device owner supplies a resource to a marketplace. The device is registered through bindIoT, a BEI Identifier is assigned, TimeYield rewards accrue during valid windows, and settlement records are generated. The marketplace lists the device resource or yield right only after verifying the BEI Identifier, active device status, relevant settlement records, and policy eligibility.

Marketplace endpoints may include BEIMarket or BEIMarkets examples, but the invention is not limited to those names. Any marketplace, licensing platform, wallet, registry, exchange, dashboard, or domain endpoint that consumes the disclosed verified records may interoperate with the module.

### 23. Currency Stream Mapping and Reference Values

The OmniHub or BEI Identifier mapping module may correlate TimeToken streams with fiat, cryptocurrency, BEI Currency, TimeCurrency, or other reference streams for accounting, display, conversion reference, or settlement reference according to a policy profile. This does not require a particular external exchange or clearing venue.

A wallet may display a TimeToken amount and a reference value. A marketplace may price a resource in TimeTokens while also showing a currency-reference value. A settlement record may include both a TimeToken amount and a reference amount. The policy profile may specify whether conversion is informational only, allowed, delayed, restricted, or subject to compliance review.

Because reference values may change over time, the settlement record may bind the reference value to a time window, policy identifier, reference stream identifier, and ledger commitment. This reduces ambiguity regarding the applicable rate or value at the time of settlement.

### 24. Pseudocode Implementations

function streamPay(request): resolve or generate a BEI Identifier for the entity and resource; load the policy profile for the requested time window; verify account and resource availability; open a stream state; accrue fractional TimeTokens by time window; emit partial settlement records; pause or resume as required; close the stream; and commit a final settlement record.
function bindIoT(deviceRecord): verify the device or gateway signature; validate the resource category; generate or resolve a BEI Identifier; create a binding record including resource category, policyID, account reference, endpoint reference, and ledger commitment; return binding status and endpoint information.
function calculateTimeYield(record): obtain demand factor, scarcity factor, reliability score, latency penalty, availability factor, and policy multiplier; compute a reward rate; create a TimeYield record linked to the BEI Identifier and settlement record; and update wallet, dashboard, or downstream endpoint state according to policy.
function reconcileFallback(records): for each cached record, verify signature, check duplicate counters, validate time windows, validate BEI Identifier binding, reject invalid records, convert valid records into settlement records, commit ledger references, and update device or stream state.
function mintFromEvent(event): resolve the BEI Identifier, validate the time window, load the policy profile, evaluate evidence or attestation references, calculate eligibility, issue a TimeToken or TimeCurrency unit if eligible, generate a settlement record, and commit the ledger reference.

### 25. Formal Algorithms

Algorithm A—Continuous TimeToken Streaming: receive stream request; resolve BEI Identifier; load policy profile; verify account and resource availability; open stream state; accrue fractional TimeTokens; emit partial settlement records; pause or resume as required; close stream; commit final settlement record.

Algorithm B—IoT Binding: receive bindIoT request; verify device or gateway signature; validate resource category; generate or resolve BEI Identifier; create binding record; commit binding record; return status and endpoint information.

Algorithm C—Behavioral or Resource Token Issuance: receive BEI Identifier-bound behavior or usage event; verify time slice; load policy profile; evaluate evidence, device, or attestation reference; compute eligibility; issue TimeToken or time-denominated credit if eligible; create settlement record; commit ledger reference.

Algorithm D—Fallback Reconciliation: receive cached signed records; verify source signatures; validate counters and nonces; check time windows; reject duplicates or stale records; convert valid cached records into settlement records; commit ledger references; update device state.

Algorithm E—Endpoint Routing: receive a protocol message; resolve the BEI Identifier and policy profile; identify permitted endpoint types; verify endpoint record signatures and effective windows; route streamPay, bindIoT, TimeYield, query, audit, wallet, marketplace, or settlement messages to authorized endpoints.

### 26. Example Implementations

Example 1—Energy meter. A smart meter is registered through bindIoT and receives a BEI Identifier. Usage windows are signed by the device or gateway. The streamPay engine debits fractional TimeTokens; the TimeYield engine may reward a provider during scarcity windows; and settlement records are committed for audit.

Example 2—Cloud compute. A compute service opens a streamPay session for compute cycles or API calls. The stream pauses when compute stops, resumes when usage resumes, and produces partial and final settlement records linked to the BEI Identifier.

Example 3—Bandwidth market. A network gateway is bound to a bandwidth resource category. Consumers stream access using TimeTokens. The device owner earns TimeYield based on demand, scarcity, latency, and reliability.

Example 4—Sensor data. A sensor feed is registered as a data resource. Consumers pay by time window or data-access window. If the sensor loses connectivity, signed cached records are reconciled later.

Example 5—Behavior event. A behavior-time event tagged with a BEI Identifier and time slice is evaluated by BEIMINTING. If policy criteria are satisfied, a TimeToken or TimeCurrency unit is issued and a settlement record is generated.

Example 6—Physical asset access. A tool, room, vehicle, workstation, or shared asset is registered through bindIoT. Access begins when a streamPay session is authorized and ends with a final settlement record.

Example 7—Marketplace listing. A downstream marketplace endpoint receives verified settlement records, TimeYield records, or evidence-token references and lists a resource, yield right, license, or access right only after policy validation.

Example 8—Treasury reserve. A treasury endpoint holds reserved TimeTokens or pending rewards until settlement conditions are met. The treasury endpoint references settlement records and policy versions rather than relying on unverified balances.

Example 9—Trust endpoint. A trust endpoint evaluates device status, identity anchor status, policy validity, and endpoint authorization before allowing a stream or query. The trust endpoint does not need to reveal private identity data if a commitment is sufficient.

Example 10—Currency reference. A currency-reference endpoint displays a TimeToken amount together with a reference value, binding the reference to a time window and policy profile for audit.

### 27. Detailed Record Lifecycles

Creation: A record is created when a stream opens, device is bound, usage event is submitted, TimeYield reward is calculated, minting event is evaluated, or fallback record is reconciled. Creation may produce a status code, settlement record, ledger commitment, or endpoint response.

Validation: The system validates BEI Identifier binding, policy status, signatures, counters, nonces, validity windows, device state, meter readings, account status, and endpoint authority. Validation results control later streaming, reward, query, or settlement actions.

Authorization: A policy profile determines whether a stream may open, whether a resource category is allowed, whether a TimeYield subscription is permitted, whether a behavior event may trigger issuance, and whether a marketplace or endpoint may access a record.

Streaming or minting: A stream accumulates fractional TimeTokens by time window, or a BEIMINTING event issues a TimeToken or TimeCurrency unit after eligibility is confirmed. The state is not merely descriptive; it controls settlement and audit actions.

Partial settlement: Completed windows may be settled during an ongoing stream, reducing exposure and improving auditability. Partial settlement records may be linked to a final settlement record at stream close.

Final settlement: The system closes the stream, computes final amounts, applies policy adjustments, records final state, commits a ledger reference, and makes the record queryable.

Audit query: An authorized requester may query correlated records through queryOmniHub or equivalent BEI Identifier query functions. Access scope may determine whether raw evidence, commitments, totals, or status fields are returned.

Correction or dispute: If a record conflicts with policy, meter readings, counters, or signatures, the system may mark the record as disputed. A corrective settlement record may be emitted instead of deleting prior history.

Archival: Historical records may remain queryable through commitments and status values even if devices are retired, keys are rotated, or endpoint records are revoked.

### 28. Message Schemas

streamPayRequest may include entityRef, resourceRef, accountRef, requestedDuration, maxAmount, policyID, clientNonce, endpointRef, and signature. streamPayResponse may include streamID, BEI Identifier, rate, maxDuration, policyVersion, state, counterRange, settlementWindow, and signature.
bindIoTRequest may include deviceID, devicePublicKey, deviceClass, firmwareVersion, resourceType, geoParam, accountRef, policyID, endpointRef, and signature. bindIoTResponse may include BEI Identifier, bindingStatus, resourceCategory, acceptedKey, endpointReference, ledgerCommitment, and reasonCode.
subscribeYieldRequest may include accountID, BEI Identifier, resourceCategory, stakeAmount, providerRole, rewardPolicy, timeWindow, and signature. subscribeYieldResponse may include subscriptionID, eligibilityStatus, rewardPolicy, requiredAvailability, rewardWindow, and settlementReference.
queryRequest may include BEI Identifier, recordType, timeWindow, resourceCategory, behaviorTag, settlementState, and paginationToken. queryResponse may include records, commitments, statusSummary, nextPageToken, proofReferences, and accessScope.

### 29. Claim-Oriented Technical Effects

The disclosed system is not a mere billing rule. It requires BEI Identifier binding, streamPay state control, bindIoT registration, usage-event validation, TimeYield calculation, fallback reconciliation, endpoint routing, and tamper-evident settlement records. These structures improve computer-based resource metering and settlement.

The system is not merely a conventional IoT platform. A conventional IoT platform may collect telemetry, but the disclosed module binds telemetry to a TimeToken account, time window, resource category, BEI Identifier, policy profile, TimeYield record, and settlement record. This binding permits telemetry to be used for continuous economic settlement and audit.

The system is not merely a conventional token streaming contract. A token streaming contract may transfer tokens over time, but the disclosed module integrates device registration, resource-category binding, behavior-triggered issuance, dynamic TimeYield rewards, fallback off-chain reconciliation, domain endpoint routing, and audit-ready settlement commitments.

The system is not merely a brand or domain name. BEI-controlled endpoints are implementation examples. Equivalent systems performing the same BEI Identifier-bound streaming, validation, reward, reconciliation, and settlement functions are within the disclosed architecture.

### 30. Alternative Implementations

The disclosed module may be implemented using public blockchains, permissioned ledgers, private ledgers, append-only logs, Merkle trees, signed databases, off-chain settlement channels, smart contracts, cloud services, edge gateways, IoT firmware, mobile applications, web applications, domain gateway services, wallet systems, marketplace systems, audit systems, or hybrid combinations thereof.

The TimeToken amount may be streamed as a debit from a consumer account, a credit to a provider account, a reserved balance, a netted amount, an escrowed amount, an issued credit, a reward amount, or an accounting entry. The protocol may support different time granularities for different services or devices.

The BEI Identifier may be generated once at registration or dynamically for each time window. A persistent identifier may identify a device or entity, while a session-level identifier may identify a usage period. A settlement record may reference persistent and session-level identifiers.

The TimeYield engine may be centralized, decentralized, smart-contract based, oracle-assisted, edge-gateway implemented, or hybrid. Reward calculation may be deterministic or may reference signed external metrics, provided that the policy profile specifies allowed parameters.

### 31. Advantages

The disclosed module creates a hard technical gate between unverified telemetry and auditable TimeCurrency settlement. A connected device or behavior source cannot merely claim value; it must pass BEI Identifier binding, policy validation, usage-event validation, streamPay or BEIMINTING evaluation, and settlement-record generation.

The system reduces fragmentation between device telemetry and economic settlement by linking devices, resources, behaviors, time windows, accounts, TimeToken streams, TimeYield rewards, and settlement records through BEI Identifier-bound records.

The system improves continuous resource settlement by using a streamPay state machine with pause, resume, partial settlement, and close states. It improves intermittent device reliability by caching signed usage records and reconciling them after connectivity is restored.

The system supports technology transfer and licensing because the technical interfaces can be implemented by IoT platforms, cloud platforms, API billing systems, energy meters, EV charging systems, sensor data markets, edge compute platforms, wallets, marketplaces, index providers, audit systems, and downstream clearing endpoints.

### 32. Conclusion

The disclosed BEI Identifier-bound TimeCurrency module provides a concrete, machine-implementable pathway for IoT and resource usage to become auditable TimeCurrency settlement. The module binds identity, devices, gateways, behavior tags, resource categories, time windows, token streams, TimeYield records, and settlement records into a verifiable path.

By combining BEI Identifier binding, BEIDID identity anchoring, BEI-IDF data structures, streamPay continuous settlement, bindIoT registration, TimeYield reward calculation, BEIMINTING issuance, BEITOKEN registry support, BEINFT evidence-token support, fallback reconciliation, BE Bridge and BEI Flow endpoint routing, and downstream market/index/clearing interoperability, the system provides a hard technical bridge between real-world usage and time-denominated value.

The invention is not limited to any single name, website, domain, endpoint, ledger, marketplace, wallet, exchange, or commercial implementation. The protected architecture is the BEI Identifier-bound technical sequence that admits, streams, rewards, validates, reconciles, records, queries, and audits TimeCurrency events.

APPENDIX A
Non-Limiting BEI Endpoint Families

| Family | Non-limiting examples | Technical role |
|---|---|---|
| Identifier | BEI Identifier, BEIDID, | Protocol-native binding, |
| | BEI-IDF, TimeID, | routing, verification, |
| | BehaviorID, DeviceID, | query, settlement, |
| | ResourceID, ReceiptID | audit |
| IoT and | BEI IoT, BEI Bridge, | Device registration, |
| bridge | BEI Flow | event flow, streamPay, |
| | | TimeYield, reconciliation |
| Minting and | BEIMINT, | Minting eligibility, token |
| token | BEIMINTING, | metadata, token status, |
| | BEITOKEN | wallet display |
| Evidence and | BEINFT, BEI Market, | Evidence-token references, |
| market | BEI Markets | listing, licensing, |
| | | marketplace routing |
| Time | BEITIME, TimeCurrency, | Time-window identity, |
| | TimeToken, TimeID, | time-denominated value, |
| | TimeChain, TimeMinting | stream settlement |
| Treasury and | BEI Treasury, | Reserve, escrow, trust, |
| trust | BEI Trust, | policy, domain routing |
| | BEI TLD | |
| Downstream | BEIIndex, BEISEC, | Index, compliance, |
| finance | BEICX, BEIGX, | clearing, exchange, |
| | BEISX, BEIUSD, | currency-reference |
| | BEICNY, BEIEUR | endpoints |

The listed names and domain endpoints are examples only. They do not limit the invention, and equivalent endpoint names, operators, websites, ledgers, wallets, marketplaces, exchanges, clearinghouses, or commercial implementations may be used.

### Appendix B—Supportive Data Structures

### BEIIdentifierRecord

identifier; class; scope; subject; timeWindow; policyID; endpointReference; integrityCode; ledgerCommitment; status

### UsageEventRecord

eventID; BEIIdentifier; deviceID; resourceID; behaviorTag; startTime; endTime; duration; rate; meterReading; nonce; counter; validityWindow; policyID; signature; settlementRecordID

### TimeYieldRlecord

accountID; BEIIdentifier; resourceCategory; rewardWindow; demandFactor; scarcityFactor; latencyFactor; availabilityFactor; reliabilityScore; baseRate; policyMultiplier; rewardAmount; settlementRecordID

### SettlementRecord

settlementRecordID; BEIIdentifier; eventID; payerAccount; providerAccount; timeTokenAmount; referenceAmount; settlementState; policyID; timestamp; signature; ledgerCommitment

### 33. BEI Identifier Admission Gate

The BEI Identifier admission gate is the point at which a device, gateway, service, resource, behavior source, wallet, marketplace, or downstream endpoint becomes eligible to participate in the TimeCurrency pathway. The gate is not satisfied by a human-readable name alone. It is satisfied by machine-verifiable records including identifier fields, policy status, endpoint status, integrity values, and settlement-related references.

In operation, the gate may reject a request when the identifier has an inactive status, the endpoint record is expired, the policy profile does not authorize the resource category, a device signature cannot be verified, a time window is stale, or a prior settlement record indicates dispute or revocation. These rejection conditions distinguish the disclosed system from a conventional billing application or generic identifier registry.

The BEI Identifier admission gate may be implemented in a device gateway, smart contract, cloud service, wallet module, domain gateway, or marketplace connector. Each implementation performs the same technical function: it prevents unbound records from entering a TimeToken stream, TimeYield reward, BEIMINTING issuance, marketplace listing, or audit record.

### 34. Device Trust and Resource Trust

Device trust may be determined from registration status, key validity, firmware status, manufacturer certificate, gateway certificate, revocation history, prior dispute rate, meter consistency, uptime, and audit results. Resource trust may be determined from resource category, capacity, availability, policy class, historical settlement reliability, and endpoint reputation.

The system may maintain a trust score or trust tier associated with a DeviceID, ResourceID, BEIDID, gateway, or endpoint. The trust score may be used by streamPay authorization, TimeYield rewards, fallback reconciliation, marketplace listing, and audit sampling. A lower trust level may require shorter settlement windows, higher collateral, more frequent partial settlement, or manual review.

The trust calculations are not limited to a single formula. A policy profile may specify a scoring function, lookup table, threshold set, machine learning model, or rule set. The technical requirement is that the score be linked to the BEI Identifier-bound records and used to control system actions.

### 35. TimeID and Time-Window Control

TimeID may identify a second, minute, hour, day, week, month, year, session, epoch, event interval, resource interval, or policy-defined settlement window. A TimeID may be included in a BEI Identifier record, usage-event record, TimeYield record, minting record, settlement record, or audit query.

Time-window control is a key technical gate. A usage event outside an authorized window may be rejected. A fallback record may be accepted only if the time window falls within a permitted offline range. A reference value may be bound to a window so that later currency-display or market-display functions do not change the historical settlement value.

Time-window granularity may differ by resource category. Compute may use seconds or milliseconds, energy may use meter intervals, physical assets may use access sessions, and behavior events may use policy-defined time slices. The system preserves the common path by binding the time window to the BEI Identifier and settlement record.

### 36. BehaviorID and Behavior-Time Events

BehaviorID may identify a behavior category rather than disclose private personal facts. A behavior-time event may include a BehaviorID, TimeID, BEI Identifier, evidence reference, source signature, policyID, eligibility value, and settlement record. Raw evidence may remain off-chain or under policy-controlled access.

The behavior-triggered issuance pathway is optional in some IoT deployments but important for BEI ecosystem deployments. A behavior event may be a work event, service event, learning event, care event, health-related event, environmental event, productivity event, resource contribution, or other policy-defined event. The system does not require every behavior category to be minted; policy controls eligibility.

When behavior-triggered issuance is enabled, the BEIMINTING layer does not merely reward a user. It creates a machine-verifiable path from BehaviorID and TimeID to issued TimeToken or TimeCurrency units, settlement records, and audit commitments.

### 37. ResourceID and Resource Categories

ResourceID may identify compute, bandwidth, energy, storage, data, sensor output, physical asset access, mobility, API service, gateway service, behavior-event source, or another policy-defined category. Each ResourceID may be associated with rate schedules, TimeYield formulas, fallback rules, audit rules, and endpoint routes.

For an energy resource, the resource record may include meter class, capacity, location scope, rate profile, and settlement interval. For compute, it may include processor class, API call type, memory, storage, or service tier. For sensor data, it may include data type, sampling rate, access window, and evidence commitment. The same BEI Identifier-bound settlement path can handle these varied categories because the resource category is machine-readable and policy-linked.

Resource categories may be added without altering the core protocol. The protocol requires identifier binding, event validation, policy evaluation, stream or mint processing, settlement record generation, and audit commitment.

### 38. ReceiptID and Audit Receipts

ReceiptID may identify a stream opening receipt, partial settlement receipt, final settlement receipt, TimeYield reward receipt, behavior-triggered issuance receipt, device-binding receipt, fallback reconciliation receipt, correction receipt, dispute receipt, or audit receipt. Each ReceiptID may link to a settlement record and a ledger commitment.

The receipt is a technical artifact, not merely a customer invoice. It binds the BEI Identifier, event, time window, policy profile, amount, state, signature, and ledger commitment. A wallet, dashboard, marketplace, treasury endpoint, audit endpoint, or downstream clearing endpoint may query the receipt to determine status.

When a record is corrected or disputed, the system may add a corrective receipt rather than delete the original record. This maintains audit continuity and supports regulatory replay or technical troubleshooting.

### 39. BEI IoT Application Endpoint

A BEI IoT application endpoint may provide device onboarding, gateway registration, resource-category selection, streamPay session display, TimeYield status, usage-event submission, fallback reconciliation status, and settlement-record queries. A user interface may show active streams, paused streams, rewards, disputes, device trust, and audit commitments.

Examples of BEI IoT endpoints may include application endpoints, organization endpoints, systems endpoints, and regional pilot endpoints. These names are implementation examples. A third-party IoT platform may implement the same APIs and still fall within the technical architecture if it performs BEI Identifier-bound registration, streaming, reward calculation, reconciliation, and settlement.

The BEI IoT endpoint may also expose SDKs or device libraries for firmware, gateway software, mobile applications, cloud connectors, or marketplace connectors. Such SDKs may implement signing, counter management, retry logic, receipt verification, policy retrieval, and endpoint routing.

### 40. BEI Bridge Application Endpoint

A BEI Bridge endpoint may coordinate between identifier systems, device systems, TimeCurrency systems, token registries, wallets, marketplaces, audit systems, and settlement systems. The bridge may translate record formats, route calls, verify endpoint signatures, and preserve the BEI Identifier-bound chain of custody.

For example, an external sensor network may use a bridge adapter to submit signed usage records. The bridge resolves the BEI Identifier, validates policy, forwards valid records to streamPay or BEIMINTING, receives settlement records, and returns receipts to the external network. The bridge thereby creates interoperability without requiring the external network to own the core TimeCurrency engine.

The bridge may be hosted by a BEI-controlled endpoint or by a licensed third party. The claims are directed to the technical bridge functions, not to a particular hosting arrangement.

### 41. BEI Flow Application Endpoint

BEI Flow may provide a view of value movement through the system. A flow may include an identifier flow, event flow, resource flow, TimeToken flow, TimeYield flow, minting flow, evidence-token flow, settlement flow, marketplace flow, or audit flow. Each flow is grounded in machine-readable records rather than narrative description.

In one embodiment, a BEI Flow dashboard displays active streams, resource categories, event totals, reward windows, pending fallback records, settlement states, and downstream endpoint status. In another embodiment, BEI Flow is an internal routing service that sends events to streamPay, TimeYield, BEIMINTING, token registry, evidence-token, wallet, or settlement endpoints.

The BEI Flow label is a non-limiting implementation example. Equivalent flow services can perform the same technical operations under different names.

### 42. BEIMINT and BEIMINTING Endpoint

A BEIMINT endpoint may process BEI Identifier-bound usage events, behavior-time events, device records, resource records, or evidence references and issue TimeTokens, TimeCurrency units, BEI-linked value units, or time-denominated credits according to policy. The endpoint may return a minting status, issued amount, settlement record, and ledger commitment.

A BEIMINTING endpoint may expose workflow interfaces for event validation, eligibility evaluation, evidence-reference handling, receipt generation, and ledger commitment. A request may be rejected if the event is unbound, stale, duplicated, unsigned, under-evidenced, beyond a policy cap, or linked to a revoked device or identity anchor.

The endpoint may interoperate with a token registry, evidence-token endpoint, wallet, marketplace, treasury, index, or audit endpoint. Interoperation is optional and policy-controlled.

### 43. BEITOKEN Endpoint

A BEITOKEN endpoint may store metadata for TimeTokens, TimeCurrency units, BEI-linked value units, minted units, reserved units, escrowed units, or displayed wallet units. Metadata may include token class, issued amount, policy profile, status, related settlement record, evidence commitment, wallet-display value, and compatibility information.

In a licensed deployment, the token endpoint may certify that a token record is compatible with the BEI Identifier-bound TimeCurrency protocol. Certification may be based on record fields, policy version, settlement status, ledger commitment, and endpoint signatures.

The token endpoint does not define the full invention by itself. It is a downstream or associated endpoint that consumes records produced by the disclosed module.

### 44. BEINFT Evidence Endpoint

A BEINFT evidence endpoint may reference or create evidence tokens associated with device-binding records, usage-event records, minting records, TimeYield records, settlement records, audit commitments, or license records. Evidence tokens may be non-fungible because each corresponds to a unique event, device, resource, receipt, or evidence package.

Evidence tokens may represent proof references, not necessarily transferable financial instruments. A policy may restrict transfer, visibility, licensing, retention, or revocation. The endpoint may be useful for patent assets, IoT device proofs, resource-use proofs, behavior evidence, or settlement receipts.

By linking evidence tokens to BEI Identifier-bound records, the system allows downstream market and audit endpoints to verify the origin and status of an asset or claim.

### 45. BEI Market Endpoint

A BEI Market endpoint may receive verified usage-event records, TimeToken streams, TimeYield records, device-binding records, minting records, settlement records, or evidence-token references from the TimeCurrency IoT settlement module. It may provide listing, discovery, licensing, access-control, pricing-reference, audit-query, or settlement-routing interfaces.

A marketplace listing may be conditioned on active identifier status, device trust, policy eligibility, current settlement state, and audit commitment. A marketplace may list device usage rights, resource access rights, TimeYield rights, evidence tokens, license packages, tokenized records, or service subscriptions. The listing is downstream of the technical settlement path.

The BEI Market and BEI Markets names are examples of marketplace endpoints. The disclosed module can interoperate with any compatible marketplace endpoint.

### 46, BEIIndex and Analytics Endpoint

A BEIIndex endpoint may aggregate usage-event records, TimeToken streams, TimeYield records, minting records, evidence-token references, settlement records, device trust scores, resource availability, and policy states into signed reports or analytics. The endpoint may generate device indexes, resource indexes, TimeCurrency indexes, behavior-time indexes, settlement indexes, or reliability indexes.

Indexing is downstream of verified records. The index endpoint does not create truth independently; it computes reports from BEI Identifier-bound records and commitments. This preserves the chain from event evidence to analytics output.

In 293, index endpoints are non-limiting downstream examples. A separate financial or market CIP may claim index admission, exchange listing, and clearing details more directly.

### 47, BEISEC Compliance Endpoint

A BEISEC or equivalent compliance endpoint may evaluate policy, security, audit, risk, eligibility, device trust, identity tier, endpoint signature, jurisdiction profile, or suspicious-event flags before permitting stream opening, minting, query access, marketplace display, index reporting, or downstream clearing. The endpoint may return approve, deny, hold, review, downgrade, suspend, or audit-required status.

Compliance endpoint examples do not convert the present module into a securities or exchange system. In this application, they are endpoint examples that can consume or gate BEI Identifier-bound TimeCurrency records. A separate CIP may address exchange admission, securities classification, or clearinghouse functions in greater depth.

### 48. BEICX, BEIGX, BEISX, and Currency-Reference Endpoints

BEICX, BEIGX, BEISX, BEIUSD, BEICNY, and BEIEUR may be downstream examples of clearing, exchange, settlement, or currency-reference endpoints. The TimeCurrency IoT module may supply upstream records to such endpoints, including usage events, TimeToken streams, TimeYield records, minting records, evidence-token references, and settlement records.

The present module does not require any downstream endpoint to be used. It remains complete as an identifier-bound IoT and TimeCurrency settlement module. However, downstream endpoints may consume its records for display, reference values, clearing status, exchange listing, audit, or compliance.

This boundary prevents the claim from being limited to a financial marketplace while preserving a clear integration path for asset-package valuation and licensing.

### 49, BEITIME Endpoint Family

BEITIME endpoints may provide TimeID binding, time-window dashboards, TimeCurrency documentation, TimeToken stream display, TimeChain records, TimeCore policy definitions, TimeMinting workflows, and TimeYield interfaces. These endpoints may host user-facing, developer-facing, or protocol-facing interfaces.

BEITIME endpoints are particularly aligned with the 293 module because the module operates by time windows. Each usage event, TimeYield reward, streamPay debit, minting event, and settlement record can be associated with a TimeID or time-window field.

The names of BEITIME domains are not limiting. They are examples of endpoints that make the time-based aspects of the TimeCurrency protocol accessible.

### 50. BEI Treasury and Reserve Endpoint

A BEI Treasury endpoint may hold TimeTokens, pending rewards, escrowed balances, reserved maximum stream amounts, settlement reserves, or policy-governed value units. When a stream opens, a treasury endpoint may reserve a maximum amount. When the stream closes, unused balance may be released and settlement records may be committed.

Treasury endpoints may also support TimeYield distribution, marketplace escrow, device-owner rewards, evidence-token custody, and settlement-state display. They may be integrated with wallets, market endpoints, or audit endpoints.

The treasury function is not required for every implementation, but it supports commercial deployment and licensing by providing a reserve and custody interface for TimeCurrency records.

### 51. BEI Trust Endpoint

A BEI Trust endpoint may evaluate BEIDID status, device trust, endpoint trust, policy trust, audit authorization, attestation source reliability, and key revocation. Trust determinations may influence whether a stream may open, whether a record is accepted, whether TimeYield accrues, whether minting is permitted, or whether marketplace display is allowed.

Trust endpoints may expose human-readable dashboards or machine-readable APIs. A trust endpoint may return a trust tier, status code, risk flag, or audit requirement. Trust may be recalculated as settlement and dispute records accumulate.

By separating trust from raw identity disclosure, the system can support privacy-preserving deployment while still maintaining accountability.

### 52. BEI TLD and Domain Gateway Endpoint

A BEI TLD or Domain Gateway endpoint may provide namespace routing, service discovery, endpoint record verification, policy-based route selection, and domain-specific service resolution. An endpoint record may include endpoint type, URL, public key, policy version, effective time window, signature, and status.

Namespace routing allows a general TimeCurrency protocol to interoperate with energy, mobility, medical, cloud, education, marketplace, treasury, trust, audit, or settlement domains without changing the core protocol. A domain may host an endpoint, but the technical function is the authenticated route and policy-controlled service resolution.

Domain endpoint examples are useful for commercialization and implementation, but they are non-limiting.

### 53. Implementation Boundary for 293

This application focuses on BEI Identifier-bound IoT, resource, behavior-event, streamPay, TimeYield, fallback settlement, and audit-record infrastructure. It may connect to downstream market, index, clearing, compliance, and currency-reference endpoints, but it does not require any particular downstream financial venue to operate.

This boundary is important for prosecution and licensing. The protected gate in this application is the upstream gate: identity and identifier binding, device and resource binding, continuous TimeToken stream control, TimeYield calculation, signed usage-event validation, fallback reconciliation, settlement-record generation, and endpoint routing.

Financial exchange admission, securities classification, national clearing, ISO 20022 clearing messages, Travel Rule payloads, or CBDC/fiat rails may be addressed in a separate CIP or related application. They may consume records generated by this module, but they are not necessary to practice the module.

### 54, Licensing and Technology Transfer Interfaces

The module may be licensed as an SDK, API, gateway service, smart contract package, device firmware library, cloud connector, wallet connector, marketplace connector, audit connector, or domain gateway adapter. A licensee may implement device registration, streamPay, TimeYield, fallback reconciliation, BEI Identifier binding, and settlement records without adopting all BEI downstream endpoints.

This modular licensing structure is commercially important. IoT manufacturers may license bindIoT and fallback reconciliation. Cloud platforms may license streamPay and TimeToken settlement. Energy providers may license TimeYield and device rewards. Marketplaces may license record verification and listing eligibility. Wallets may license receipt and query functions.

The patent claims should therefore remain broad enough to cover equivalent implementations while the specification identifies BEI ecosystem endpoints as non-limiting examples.

### 55. No Limitation by Domain Name, or Brand

References to BEI Identifier, BEIDID, BEI-IDF, BEI IoT, BEI Bridge, BEI Flow, BEIMINT, BEIMINTING, BEITOKEN, BEINFT, BEI Market, BEIIndex, BEISEC, BEICX, BEIGX, BEISX, BEITIME, BEI Treasury, BEI Trust, BEI TLD, or related endpoint names are implementation examples and ecosystem terminology. They do not limit the invention to a particular brand, website, operator, or domain name.

Likewise, references to specific domain names are examples of BEI-controlled endpoints that may host documentation, APIs, registries, dashboards, wallets, marketplaces, or service endpoints. The invention covers equivalent endpoints performing the claimed functions under any name.

The claims should be interpreted according to the functional engines, records, workflows, state transitions, validation checks, and settlement commitments described herein.

### 56. Final Hard-Gate Summary

The hard gate created by the disclosed module may be summarized as follows. A connected device, gateway, service, resource, behavior source, or endpoint must be registered or resolved through a BEI Identifier; usage or behavior must occur within a valid time window; a streamPay, TimeYield, or BEIMINTING process must apply policy; signed records must pass validation; offline records must be reconciled; and a settlement record must be committed for audit.

This gate is comparable to a technical canal connecting upstream real-world or digital activity to downstream TimeCurrency assets. Without the gate, downstream wallets, markets, indexes, treasuries, trust systems, or clearing systems lack verified upstream records. With the gate, the system provides the verified records necessary for austenization, licensing, audit, and settlement.

The disclosed architecture is therefore not a general idea of time money or IoT billing. It is a concrete record-based, identifier-bound, state-machine-driven, reward-aware, reconciliation-capable, endpoint-routable settlement system.

### 57. BEI Identifier Registry Operation

A BEI Identifier registry may store active, pending, suspended, revoked, disputed, retired, and archived states for identifiers. The registry may be implemented as a smart contract registry, permissioned ledger table, signed database, append-only log, domain gateway record, or hybrid combination. The registry may return machine-readable status codes to streamPay, bindIoT, TimeYield, BEIMINTING, wallet, audit, and marketplace endpoints.

Identifier registry operation creates a practical gate for commercialization. A licensee may deploy compatible devices or endpoints only if those devices or endpoints can resolve identifier status, policy status, and endpoint status. This prevents unregistered telemetry from being treated as settlement-grade TimeCurrency evidence.

The registry may include API methods such as registerldentifier, resolveIdentifier, updateStatus, rotateKey, revokeIdentifier, linkEndpoint, querySettlementState, and verifyCommitment. These function names are illustrative; equivalent functions may be implemented under different names.

### 58. Policy Profile Versioning

Policy profile versioning enables the module to operate across different industries and jurisdictions without changing the core protocol. A policy profile may define rate tables, reward factors, required evidence fields, fallback limits, maximum offline duration, endpoint permissions, time-window granularity, marketplace eligibility, audit requirements, and dispute procedures.

Each usage event and settlement record may reference the policy version applied at the time of processing. This allows later audit systems to reconstruct the applicable rule set even if the policy is updated later. A policy update may be signed and may have an effective time window.

Policy versioning also supports licensing because different customers can operate different resource categories, rates, and trust requirements while using the same BEI Identifier-bound TimeCurrency protocol.

### 59, Wallet and Dashboard Interfaces

A wallet endpoint may display active streams, TimeToken balances, reserved amounts, TimeYield rewards, pending fallback records, minted units, evidence-token references, settlement receipts, and audit commitments. A dashboard endpoint may show device status, stream status, endpoint status, trust score, policy status, and reconciliation status.

The wallet or dashboard may query records by BEI Identifier, TimeID, DeviceID, ResourceID, ReceiptID, settlement state, policyID, or endpoint reference. Access control may restrict which fields are visible to a user, device owner, service provider, auditor, marketplace, or treasury operator.

The wallet interface is not merely a display screen. It consumes machine-verifiable settlement records and commitments and may trigger pause, resume, dispute, audit, escrow, or reconciliation actions according to policy.

### 60. Smart Contract and Ledger Embodiments

In a smart-contract embodiment, contracts may maintain stream states, balances, counters, settlement records, TimeYield reward states, and identifier registry references. Device records may be submitted by authorized gateways. Contract events may function as ledger commitments.

In a permissioned-ledger embodiment, authorized nodes may maintain device registry, policy profiles, stream records, reward records, and settlement records. The permissioned ledger may provide privacy controls and lower latency while preserving auditability.

In a hybrid embodiment, cloud services or edge gateways may manage real-time state and periodically commit hashes to a ledger. This reduces transaction load while preserving tamper-evident proof of record sequences.

### 61. Edge Gateway Embodiments

An edge gateway may aggregate usage events from multiple devices, validate local signatures, manage offline counters, batch records, apply local policy, and submit reconciled commitments when connectivity is available. The gateway may also act as a bridge between legacy devices and the BEI Identifier-bound TimeCurrency protocol.

For example, legacy meters may submit ordinary meter readings to an edge gateway. The gateway may wrap readings into UsageEventRecords, attach BEI Identifier references, sign batches, and submit records to streamPay or settlement services. The gateway may create a gateway-level settlement receipt while retaining device-level evidence references.

Edge gateway embodiments are commercially significant because many field devices cannot be updated quickly. A gateway adapter allows the patented settlement path to be licensed without replacing every device.

### 62. Interoperability with Legacy Billing

The module may coexist with legacy billing systems. A legacy billing system may receive settlement records, reference amounts, time windows, or receipt identifiers from the TimeCurrency module. Conversely, a legacy system may provide account status, rate schedules, or invoice references to a policy profile.

The technical bridge preserves record integrity by maintaining BEI Identifier-bound usage events and settlement commitments even when an external billing system performs invoicing or accounting. This separation allows gradual adoption and licensing to existing service providers.

The disclosed system therefore does not require immediate replacement of existing billing. It can serve as a settlement-grade event layer, an audit layer, a token-streaming layer, or a reconciliation layer.

### 63. Prosecution-Oriented Distinctions

The disclosed system improves the operation of device and network settlement systems by producing consistent machine-verifiable records for events that otherwise remain fragmented across telemetry, wallet, billing, and ledger databases. The use of BEI Identifier binding, streamPay state control, TimeYield computation, fallback reconciliation, and settlement commitments is a concrete technical architecture.

The claims should not be understood as directed to a result without means. The specification discloses engines, state machines, record fields, validation rules, fallback reconciliation, endpoint routing, APIs, pseudocode, message schemas, and examples of implementation in smart contracts, gateways, cloud services, wallets, marketplaces, and ledgers.

The combination is not merely the predictable use of a generic token stream. It joins device/resource registration, identifier-bound usage validation, dynamic reward calculation, offline record reconciliation, and endpoint-routable settlement records into one TimeCurrency pathway.

### 64. Asset-Package Implementation Value

The module can be positioned in a patent asset package as the BEI IoT and continuous settlement bridge. Its value is strongest when paired with broader BEI Currency, BEIMINT, BEITOKEN, BEINFT, BEI Market, BEIIndex, BEICX, BEIGX, BEISX, BEISEC, BEITIME, BEI Treasury, BEI Trust, and BEI TLD assets. Those downstream systems may consume the records generated by this module.

The hard licensing point is that an implementer seeking to connect devices, resources, behavior-time events, TimeToken streams, TimeYield rewards, and settlement records must implement the identifier-bound gate. That gate is independent of the particular website or commercial operator used for deployment.

Accordingly, the module supports technology transfer, product demonstrations, SDK licensing, standards compatibility, marketplace integration, wallet integration, treasury integration, audit integration, and downstream clearing or exchange interoperability.

### 65. Settlement-Grade Compatibility and Third-Party Certification Gate

The disclosed module may be implemented not only as an internal BEI ecosystem component, but also as a settlement-grade compatibility gate for third-party systems. A third-party IoT platform, energy network, bandwidth gateway, cloud service, sensor network, API billing platform, medical-device network, marketplace, wallet, index provider, or audit system may maintain its own user interface, token name, database, or commercial platform while using the disclosed identifier-bound validation and settlement path to convert raw usage data into a settlement-grade record.

A settlement-grade record is a machine-verifiable record that has passed identifier binding, policy authorization, endpoint verification, signature validation, nonce or counter validation, time-window validation, duplicate-settlement prevention, fallback reconciliation when applicable, and ledger-commitment or tamper-evident record generation. Such a record may be consumed by a wallet, audit endpoint, marketplace, index endpoint, clearing endpoint, licensing endpoint, treasury endpoint, trust endpoint, or compliance endpoint.

The technical significance of the compatibility gate is that a platform need not adopt every BEI endpoint name or BEI Currency interface in order to practice the invention. The platform practices the disclosed architecture when it uses a protocol-native identifier gate to admit device, resource, behavior-time, or service-usage records into a verified streaming, reward, minting, settlement, audit, marketplace, or licensing path.

### 66. Marketplace-Eligible and License-Ready Resource Records

In some embodiments, a marketplace, registry, exchange, wallet, index, certification, or licensing endpoint may refuse to list, price, certify, license, tokenize, index, or display a resource right unless the corresponding usage or resource record has passed the BEI Identifier-bound gate.

The endpoint may verify active identifier status, device trust, resource authorization, policy eligibility, endpoint status, current settlement state, audit commitment, and absence of unresolved duplicate, dispute, revocation, or stale-window conditions before admitting the record.

A marketplace-eligible record may represent a device usage right, bandwidth right, compute right, energy right, sensor-data right, API access right, physical-asset access right, behavior-time contribution, TimeYield right, evidence-token reference, license package, or settlement receipt. The record is not accepted merely because an operator describes it as an asset. It is accepted because the record is linked to a verifiable identifier, signed event evidence, policy profile, time window, settlement state, and ledger commitment.

This marketplace admission function is useful for technology transfer because a licensee can implement a BEI-compatible or settlement-grade resource gateway without adopting all downstream financial or exchange functions. The patented gate provides a reliable input layer for downstream commercialization.

### 67. Certification, Standards, and Interoperability Use Cases

The disclosed architecture may support certification labels or protocol compatibility designations, including non-limiting labels such as BEI-compatible, BEI-verified, settlement-grade, audit-ready, market-eligible, wallet-verifiable, indexable, license-ready, or clearing-consumable. The label is not the invention; the invention is the machine process that creates the verified record supporting the label.

A certification endpoint may receive a third-party usage-event record, resolve or assign a protocol-native identifier, validate device or gateway identity, validate policy and time-window parameters, verify the event signature and replay-prevention values, and return a certification receipt linked to a settlement record. The receipt may be displayed by a wallet, market, dashboard, auditor, or licensing platform.

This standardization use case increases commercial utility because independently operated systems may interoperate around a common settlement-grade proof format while retaining their own brands, tokens, ledgers, billing systems, or user interfaces.

### 68. Independent Operation Without Limitation to BEI Branding

The disclosed system is not limited to a requirement that every implementer enter a BEI Currency website or use a BEI-named user interface. An implementer may use alternative names, domains, tokens, ledgers, wallets, marketplaces, dashboards, or billing interfaces. What matters technically is whether the implementer performs the claimed identifier-bound registration, validation, streaming, reward, reconciliation, and settlement-record functions.

A system that maintains its own platform may still require the patented gate when it seeks to make IoT, resource, behavior-time, API, bandwidth, energy, sensor, compute, mobility, medical-device, physical-asset, or gateway-usage records acceptable to external wallets, markets, auditors, indexes, licensors, clearing endpoints, or certified asset packages.

This boundary preserves freedom for ordinary closed billing systems while protecting the settlement-grade austenization path disclosed herein. Ordinary unverified telemetry may remain outside the claims. Verified asset-grade settlement records that use the disclosed gate and record path are within the technical scope.

### 69. Stronger Non-Obvious Combination Boundary

The combination is not a mere aggregation of an identifier, a payment stream, and an IoT meter. The identifier gate changes the technical treatment of the incoming record. Before the gate, a device reading is non-settlement telemetry. After the gate, and only after satisfying policy, signature, nonce, counter, time-window, endpoint, and settlement-state conditions, the record may update a streamPay state, trigger TimeYield, support BEIMINTING, become a marketplace-eligible asset record, or generate an audit receipt.

The disclosed architecture therefore improves settlement-system integrity by preventing unbound, stale, duplicated, unsigned, policy-unauthorized, revoked, or disputed records from entering downstream financial, market, audit, wallet, or licensing systems. This improvement is technical because it controls data admission, state transitions, record integrity, replay prevention, offline reconciliation, and queryable audit outputs.

### 70. Claim Support for Settlement-Grade Admission

The foregoing settlement-grade admission functions are supported by the disclosed BEI Identifier record fields, UsageEventRecord fields, streamPay state machine, bindIoT registration workflow, TimeYield record, fallback reconciliation workflow, settlement record, endpoint routing, policy profile versioning, device trust, resource trust, ReceiptID, wallet and dashboard interfaces, edge gateway embodiments, legacy billing interoperability, and marketplace endpoint examples.

The claims may therefore be drafted to recite rejection of a usage event or resource listing unless active identifier status, valid endpoint status, policy authorization, signature verification, replay-prevention values, time-window validity, device or gateway trust, and settlement-state conditions are satisfied. These limitations capture the hard technical gate without limiting the invention to any one domain name, commercial brand, or downstream exchange.

1. A computer-implemented settlement-grade admission system for identifier-bound continuous value streaming and Internet-of-Things resource settlement, comprising one or more processors configured to: receive a registration record for at least one connected device, gateway, service, resource, or behavior-event source, the registration record including at least a device or gateway public key, a resource category, a policy identifier, and an endpoint reference; generate or resolve a protocol-native BEI Identifier associated with the registration record; store or reference a BEI Identifier record including identifier status, policy status, endpoint status, integrity information, and a ledger-commitment field; receive a signed usage-event record including a device identifier, resource identifier, time-window value, meter or usage value, nonce or counter value, policy identifier, and signature; reject the signed usage-event record from a TimeCurrency settlement path unless the BEI Identifier has an active status, the endpoint status is valid, the policy identifier authorizes the resource category, the signature is verified, the nonce or counter value satisfies a replay-prevention condition, the time-window value is within an authorized window, and no duplicate settlement, revocation, or unresolved dispute condition blocks the event; after the signed usage-event record satisfies the rejection conditions, open or update a streamPay state for a fractional TimeToken stream; generate or update a TimeYield record according to at least one demand, scarcity, latency, availability, reliability, utilization, trust, or policy parameter; reconcile cached signed usage-event records generated during intermittent connectivity; and generate a tamper-evident settlement-grade record associated with the BEI Identifier and consumable by at least one wallet, audit endpoint, marketplace endpoint, index endpoint, clearing endpoint, licensing endpoint, or certification endpoint.

2. The system of claim 1, wherein the BEI Identifier includes or references at least a class field, scope field, subject field, time-window field, policy field, endpoint-reference field, integrity field, status field, or ledger-commitment field.

3. The system of claim 1, wherein the BEI Identifier is associated with a BEIDID identity anchor corresponding to a person, entity, device owner, service provider, organization, verifier, account, gateway, marketplace operator, auditor, or licensee.

4. The system of claim 1, wherein the BEI Identifier comprises or references an OmniID implementation generated from at least an entity public key, a TimeToken account, an entity type, and one or more geographic parameters.

5. The system of claim 1, wherein the streamPay state comprises an initialization state, identifier-resolution state, authorization state, streaming state, pause state, resume state, partial-settlement state, close state, record-issuance state, dispute state, or archive state.

6. The system of claim 1, wherein the resource category is selected from compute, bandwidth, energy, storage, data, sensor output, physical asset usage, mobility, service access, application programming interface calls, behavior-event source, gateway service, medical-device usage, edge-compute usage, or legacy-meter usage.

7. The system of claim 1, wherein the signed usage-event record includes at least an event identifier, the BEI Identifier, a device identifier, a resource identifier, a behavior tag, a start time, an end time, a duration, a rate, a meter reading, a nonce, a counter, a validity window, a policy identifier, a signature, or a settlement-record reference.

8. The system of claim 1, wherein the one or more processors output a rejection code selected from stale window, duplicate nonce, invalid signature, policy exceeded, device revoked, meter conflict, insufficient balance, rate limited, endpoint expired, identifier inactive, resource unauthorized, or pending reconciliation.

9. The system of claim 1, wherein the TimeYield record includes a reward amount calculated using at least one of a demand factor, scarcity factor, latency factor, availability factor, provider reliability score, stake amount, service-quality value, utilization value, dispute rate, device-trust value, resource-trust value, or policy multiplier.

10. The system of claim 1, further comprising a BEIMINTING layer configured to evaluate a BEI Identifier-bound usage event or behavior-time event and issue a TimeToken, TimeCurrency unit, BEI-linked value unit, token record, time-denominated credit, or minting receipt only after the usage event or behavior-time event satisfies a policy-defined eligibility condition and a settlement-state condition.

11. A computer-implemented method for settlement-grade admission of identifier-bound usage events into a continuous value streaming and Internet-of-Things settlement path, comprising: receiving a registration record for a connected device, gateway, service, resource, or behavior-event source; generating or resolving a protocol-native BEI Identifier associated with the registration record; receiving a signed usage-event record associated with the BEI Identifier; rejecting the signed usage-event record unless an identifier status is active, an endpoint status is valid, a policy profile authorizes a resource category, a signature is valid, a nonce or counter satisfies a replay-prevention condition, a time window is valid, and a settlement-state condition does not indicate duplicate settlement, revocation, or unresolved dispute; after the signed usage-event record is not rejected, opening or updating a fractional TimeToken stream through a streamPay function; calculating a TimeYield reward according to one or more demand, scarcity, latency, availability, reliability, utilization, trust, or policy parameters; recording a usage event associated with the BEI Identifier; and generating a tamper-evident settlement-grade record for the usage event.

12. The method of claim 11, further comprising caching signed usage-event records during intermittent connectivity and, after connectivity is restored, reconciling the signed usage-event records by validating signatures, counters, nonces, validity windows, device status, meter readings, resource status, and policy state before committing valid records to a ledger or tamper-evident audit structure.

13. The method of claim 11, further comprising admitting a device usage right, bandwidth right, compute right, energy right, sensor-data right, application programming interface access right, physical-asset access right, behavior-time contribution, TimeYield right, evidence-token reference, license package, or settlement receipt to a marketplace, licensing, wallet, index, audit, or clearing endpoint only after verifying identifier status, device trust, policy eligibility, settlement state, and audit commitment.

14. The method of claim 11, further comprising generating a compatibility, certification, audit-ready, market-eligible, license-ready, wallet-verifiable, indexable, clearing-consumable, or settlement-grade receipt for a third-party platform while permitting the third-party platform to use its own domain name, token name, ledger, wallet, billing system, marketplace, or user interface.

15. The method of claim 11, further comprising wrapping a legacy meter reading, legacy billing record, external sensor record, edge-gateway record, or third-party telemetry record into a UsageEventRecord linked to the BEI Identifier before the record is admitted to streamPay, TimeYield, BEIMINTING, marketplace listing, audit, or settlement.

16. The method of claim 11, wherein a policy profile version controls at least a rate table, reward factor, required evidence field, fallback limit, maximum offline duration, endpoint permission, time-window granularity, marketplace eligibility condition, audit requirement, or dispute procedure, and wherein the settlement-grade record references the policy profile version applied at the time of processing.

17. The method of claim 11, further comprising storing or referencing token metadata, evidence-token metadata, minting metadata, wallet-display metadata, marketplace-listing metadata, licensing metadata, certification metadata, or audit metadata linked to the BEI Identifier-bound usage event or settlement-grade record.

18. The method of claim 11, further comprising generating an analytics dashboard or index report that aggregates BEI Identifier-bound usage events, behavior events, TimeToken streams, TimeYield records, minting records, evidence-token references, settlement-grade records, device-trust values, resource-trust values, and ledger commitments for real-time monitoring, marketplace display, governance, licensing, compliance, or audit.

19. The method of claim 11, wherein the tamper-evident settlement-grade record is stored as or committed to a distributed ledger entry, permissioned ledger entry, smart contract event, append-only log entry, Merkle commitment, signed database record, edge-gateway batch commitment, or hybrid on-chain and off-chain commitment.

20. A non-transitory computer-readable medium storing instructions that, when executed by one or more processors, cause the one or more processors to perform operations comprising: receiving or resolving a protocol-native BEI Identifier associated with a connected device, gateway, service, resource, or behavior-event source; receiving a signed usage-event record associated with the BEI Identifier; rejecting the signed usage-event record unless an active identifier status, valid endpoint status, policy authorization, valid signature, replay-prevention value, valid time window, and settlement-state condition are satisfied; after the signed usage-event record is not rejected, managing a fractional TimeToken stream through a streamPay function; calculating a TimeYield reward; reconciling cached signed usage-event records generated during intermittent connectivity; routing one or more protocol messages to a wallet, audit, marketplace, index, clearing, licensing, certification, domain-gateway, or third-party compatible endpoint; and generating a tamper-evident settlement-grade record associated with the BEI Identifier.
